(19) United States
(12) Patent Application Publication
(10) Pub. No.: US 2010/0176569 A1
(43) Pub. Date: Jul. 15, 2010

(54) VERTICAL NON -GUIDED VEHICLE SUSPENSION

(76) Inventor: Jecheskel Davidovitch, Ramat Gan (IL)

Correspondence Address: Pearl Cohen Zedek Latzer, LLP, 1500 Broadway, 12th Floor, New York, NY, 10036, US

(21) Appl. No.: 12/441,023

(22) PCT Filed: Sep. 11, 2007
(86) PCT No.: PCT/IL07/01128

§ 371 Date: Dec. 2, 2009

(51) Int. Cl. B60G 11/14; B60G 3/18

(52) U.S. Cl. 280/124.136

(57) ABSTRACT

An independent Vertical Non-guided Vehicle suspension, possibly combined with a vertical driving-shaft, pure linear substantially vertical motions of the vehicle's wheels being performed by said suspension, on traveling upon rough or disrupted roads, said motions being non-guided, thus avoiding wear as occurring in the conventional vertical guided suspensions, on being subjected to horizontal forces. The pure linear vertical motions of the vehicle's wheels, tend to ensure accurate longitudinal and crosswise distances between the vehicle's wheels, resulting in decreased wear of the tires, as well as improved driving performances, by avoiding skidding of the wheels. The operation mode of the suggested suspension, also enables to determine its springiness characteristics, as well as allowing the excluding of knuckle connections and universal joints out of the Automative system, being inevitable in the conventional automobiles in use, while also providing a remarkably extended stroke at the same total height, and maximum free internal space for the benefit of passengers and their goods.

### FIELD AND BACKGROUND OF THE INVENTION

The present invention relates to vehicle suspensions.

More particularly, the invention proposed a linear non-guided independent suspension improving the driving performance of an automobile.

As is known, vehicle suspensions are provided with suspension springs which may be of various kinds, like helical, rubber, pneumatic or torsion. Said springs serve for abating the vibrations created on driving upon rough or disrupted roads, by allowing the vehicle's wheels to perform substantially vertical motions relative to the vehicle's body. A vehicle not provided with suspensions, is subject to vibrations imparted to said vehicle's body, thus decreasing safety, increasing damage to car components and causing much distress to passengers.

While the independent suspension has been in use for many decades, improvements are constantly suggested, recent US Patents providing a picture of the state of the art.

Brill et al. in U.S. Pat. No 6,561,307 propose a drive-by-wire steering system for use in combination with an independent suspension. The suspension illustrated will not however provide straight line motion.

An independent suspension for cars is seen in U.S. Pat. No. 6,634,654 to Mackle et al. By means of an intermediate carrier and a longitudinal pivot axis the wheel camber can be adjusted, otherwise the suspension is of conventional design.

U.S. Pat. No. 6,755,429 to Buchwitz et al discloses a suspension for vehicle powered rear wheels. The suspension includes a sub-frame carrying the rear wheels, which are unsteerable. The arrangement is said to avoid caster change as the road wheel moves in jounce and rebound, but no means are provided to ensure straight-line motion.

Further vehicle independent suspensions are seen in U.S. Pat. No. 6,877,754 B2 to Kim and U.S. Pat. No. 6,921,097 B2 to Ohlsson, but neither have mechanisms to provide purely linear vertical road wheel movements.

Straight linear vertical suspensions are in principle superior functionally to those in use, due to the capability of the suggested suspension to maintain accurate and constant upward wheel camber, as well as constant longitudinal and crosswise distances between the wheels, thus avoiding skidding of said wheels.

Conventional straight linear vertical suspensions are today rarely used in automobiles due to excessive wear of the linear guide elements, as well as due to constructional limitations deriving from accommodation constraints and from the total height of said suspensions, being often well beyond their maximum effective stroke, consequently requiring extra room.

Another major limitation of said conventional straight linear suspensions is the prevention of access for a driving shaft to be attached thereto thus preventing said suspension to be utilized with driven wheels, whether front or rear.

### OBJECTS OF THE INVENTION

It is therefore one of the objects of the present invention to obviate the disadvantages of prior art independent suspensions and to provide a suspension based on a geometry which provides pure linear movement, yet without guiding the wheel by means of vertical-axis guides.

It is a further object of the present invention to provide a suspension which allows access for a drive shaft for propelling the vehicle.

### SUMMARY OF THE INVENTION

The present invention achieves the above objects by providing an independent automobile suspension providing a suspended wheel with straight linear vertical motion, comprising:
an upper main atm, its center being pivotally connected to the bottom end of an auxiliary hinged arm, the bottom end of said first main arm performing straight linear vertical motions, while the upper end of said main arm is guided along a sloped straight slide element:
a bottom main arm provided with end pivot bores identically spaced to those of said upper main arm and pivoted to be parallel to said upper main arm, the bottom ends of said two main arms being pivotally attached to a vehicle's wheel hub so as to restrict said wheel to a constant camber all along its vertical motion;
a spring, operatively connected to the suspension and to a fixed position component to support part of the weight of said automobile;

and
a shock absorber also connected between said suspension and a fixed position component of the automobile.

### Preferred Embodiments of the Invention

In a preferred embodiment of the present invention there is provided an automobile suspension, wherein means are provided for adjusting the resistance force of said spring.

In a further preferred embodiment of the present invention there is provided an automobile suspension wherein means are provided for varying suspension characteristics by adjusting the angle of said sloped straight-slide element relative to the horizontal plane.

In a most preferred embodiment of the present invention there is provided an automobile suspension in combination with a vertical drive-shaft system for driving a vehicle's road wheel by means of a bevel gear transmission, or any other transmission performing the same function.

Yet further embodiments of the invention will be described hereinafter.

The invention provides an independent straight linear non-guided vehicle suspension, possibly combined with a vertical driving shaft, straight linear vertical motions of a vehicle's wheel being performed by said suspension on traveling upon rough or disrupted roads, said motions being non guided, thus avoiding the wear occurring in the conventional known linearly guided suspensions on being subjected to horizontal forces. The paths of the wheel motions are directed straight vertical, tending to ensure accurate longitudinal and crosswise distances between the vehicle's wheels, resulting in decreased wear of the tires as well as in improved driving performances, by avoiding skidding of the wheels while performing vertical motion, as well as avoiding deviations from the intended vehicle's track. These effects are common in conventional known suspensions, and also affect wheel adherence to the ground.

The operation principles and structure of said suspension also enable adjustment of the spring rate characteristics, including possible self-restraining, and allow for a longer stroke at same total height. Furthermore, there is obtained maximum free space above and underneath the chassis, due to the suspension springs and shock absorbers being oriented near horizontally, thus avoiding the intrusion of suspension's components into the vehicle's upper space. The structure also provides access for a driving shaft to be attached thereto, as well as a 125 degrees total steering range for a “side traveling” option.

Another advantage of the new suspension is an option for maintaining the steering linkage, meaning the steering arms and their inter-connecting rod, at a plane rectangular to the steering pivots of the wheels. This allows the elimination of knuckle connections at the steering linkage which have three-dimensional motion, consequently accurate control of the driving performance becomes possible, and wear of the steering components is reduced.

Regarding the embodiments wherein the suspension is used in combination with a vertical drive shaft, which may optionally be used also as a steering pivot, it becomes possible to eliminate the knuckle connections and the universal joints at the automotive system.

In said embodiments the automobile achieves high simplicity as well as improved performance and remarkable decrease of maintenance and manufacturing costs, while providing a series of functional and constructional options, turning said automobile into an electric or a hybrid car of maximum free internal space for the benefit of passengers and their goods.

In summary, the advantages of the suspension according to the present invention are as follows:
retreat from the option of internal “wheel-motors” and braking units, thus avoiding the need for transferring electric wiring thereto, and liquids from outside to affect sensitive components, as well as avoiding added weight to the wheels.
remarkable decrease of gyro effects.
full exploitation of the vehicle's space, in favour of the passengers and their goods.
quick and easy response to the driver's operations, specifically the steering.
free access to the driving and braking components.
less inertial energy losses on braking and and speed varying due to the decreased wheel weight.
full symmetry of the vehicle at both longitudinal and crosswise axes, meaning identical forward and backward driving characteristics, avoiding the need for turning around the vehicle in order to drive backwards, except for tilting seat backs.
applicability of the “suspension drive” to the various possible propulsion systems.
option for “side-traveling” for parking as well as for turning “on spot”.
highly advantageous for implementation in electric or hybrid vehicles.

### SHORT DESCRIPTION OF THE DRAWINGS

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

In the drawings:

FIG. 1 is a geometric diagram representing a preferred embodiment of the suspension according to the invention;

FIG. 2 is an elevational view of a basic realization of the suspension;

FIG. 3 is a plan sectional view of the same embodiment;

FIG. 4 is a perspective view of the same embodiment, materializing the basic structure.

FIG. 5 is a sectioned elevational view of a second, most preferred embodiment of the suspension, in combination with a vertical drive-shaft system.

FIG. 6 is a schematic side elevational view of the second embodiment as applied to a hybrid automobile;

and

FIG. 7 is a plan view of the embodiment seen in FIG. 6

### FULL DISCLOSURE OF THE INVENTION

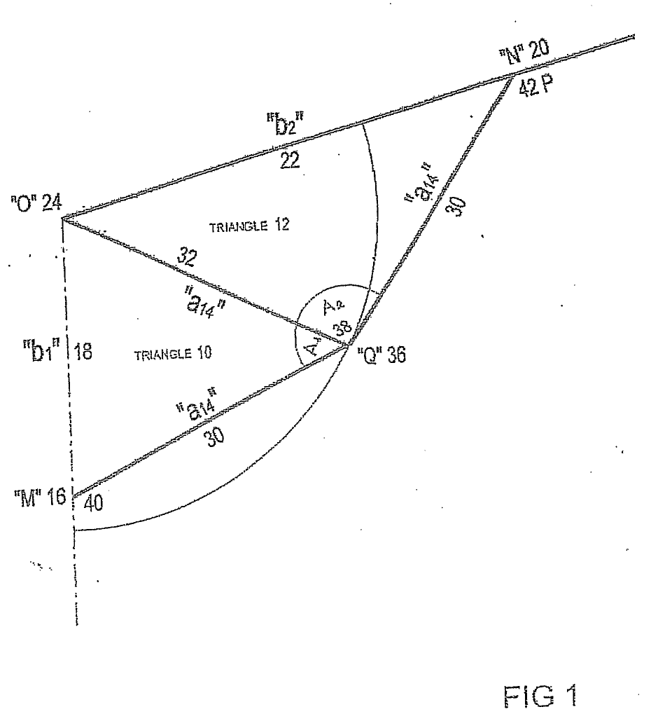

There is seen in FIG. 1 a geometric representation of the upper portion of the suspension, excluding the suspension spring and shock absorber.

The thick lines represent components, pivotally interconnected arms as well as sliding and rolling components, all integrated in a formation as illustrated.

Isosceles triangles 10 and 12 have a common side “a” 14. The outer free end “M” 16 of triangle 10 is compelled to follow a straight linear path coinciding with line “b1”18 of triangle 10, while the outer end “N” 20 of triangle 12 is moving along the fixed line “b2”22. “o”24 is a fixed point to which the common side “a” 14 is hinged. Each of the two adjacent vertical angles “A1” and “A2” of triangles 10, 12 vary accordingly, their sum being kept constant. The lower portion of the linkage will be seen in the following figures.

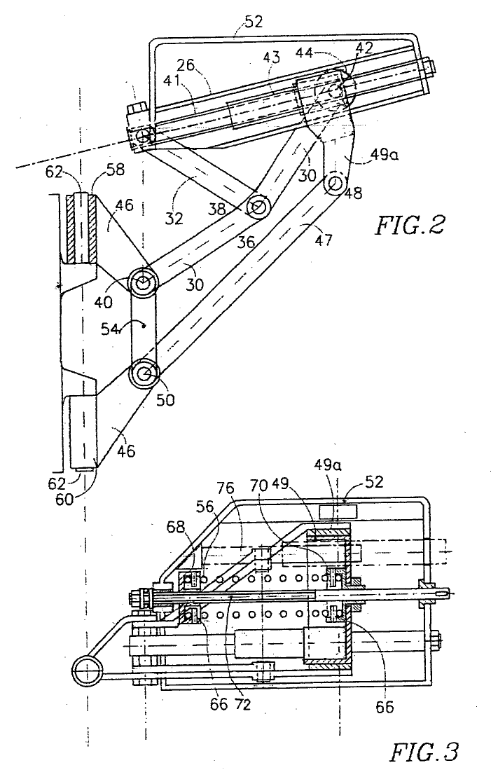

Turning now to FIGS. 2, 3 and 4, it is clearly seen that the upper portion of the suspension 26 corresponds to the geometrical representation of the straight-line linkage seen in FIG. 1. For simplicity of description, the various arms are referred to as a single arm, while in practice, as seen in FIG. 4, there are two spaced apart arms of each type, with identical pivot centers, interconnected by a rib, and forming a shallow “U” shaped profile.

An upper main arm 30 (MQN in FIG. 1) which is rigid but not straight, is at its center 36 pivotally connected to the bottom end 38 of an auxiliary hinged arm 32, the length between pivot points of the arm 32 being identical to the distance between the centre pivot point 36 of the upper main arm 30 and either end pivot 40, 42. The various arms 30, 32, 47, are suitably made, as mentioned, of a shallow “U” shaped profile. The bottom pivot 40 of the upper main arm 30 performs straight linear vertical motions, while the upper pivot 42 of the upper main arm 30 is guided along a sloped straight slide element 41 by means of a linear bearing 43 and a roller 44, both supported by a bearing slide body 49.

A bottom main arm 47, which is not represented in the diagram of FIG. 1, is provided with end pivot bores 48, 50 identically spaced to the end bores of the upper main arm 30 and pivoted to be parallel to a line connecting the end pivot points 40, 42 of the upper main arm 30. The bottom ends 40, 50 of the two main arms 30, 47 are pivotally attached to a pair of wheel carrier arms 46, supporting coaxial bearings 58, 60, for steering pins 62 to be inserted thereto, about which the wheel may be steered.

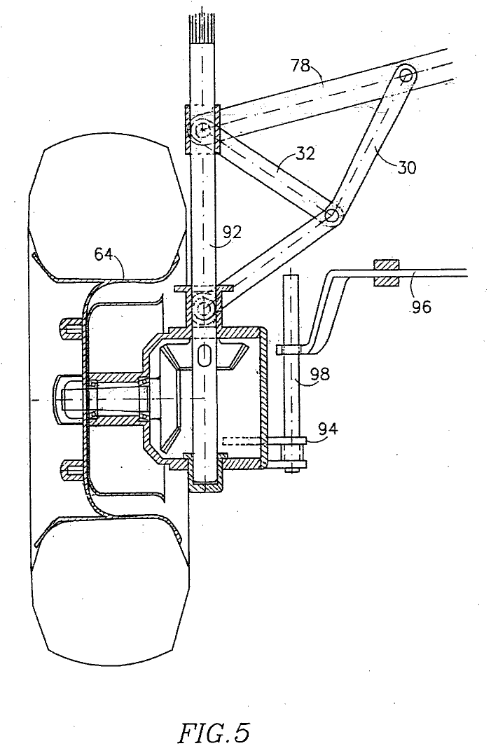

The suspension restricts the road wheel (64 in FIG. 5) to a desired constant camber all along its vertical motions.

Advantageously, a further link 54 pivotally interconnects the bottom ends 40, 50, to form a parallelogram in combination with the main arms 30, 47 and the bearing slide body 49.

A suspension tension spring 56 is operatively connected between the suspension 26 and indirectly to a fixed position frame 52, to support part of the weight of the automobile. The spring 56 is held by retainers 66 to a movable nut cap 68 and to a frame cup 70 which is attached to the moving slide body 49. A threaded shaft 72 which could be turned by a hand tool, could also be actuated by a rotary actuator 74 {shown schematically in FIG. 7 hereinafter}, to provide an option for varying the spring force, as will be required.

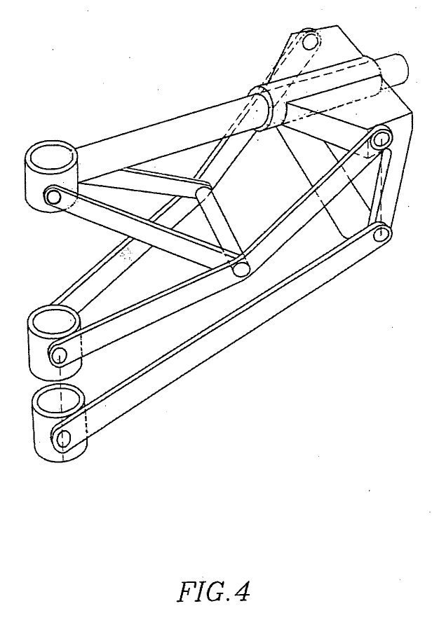

A shock absorber 76 is seen in FIG. 3, its one end attached to the bearing body 49, while the other end being fixed to frame 52. Suspension 26 may be adjusted for various inclination angles of the wheel camber, king-pin or caster, as desired.

With reference to the rest of the figures, similar reference numerals have been used to identify similar parts.

Turning now to FIG. 5, there is seen schematically an independent straight linear non-guided vehicle suspension 78, in combination with a vertical drive-shaft system, for propelling a road wheel 64, by means of any suitable drive unit, the bottom main arm 47 and all the other respective arms, wheel carriers and steering pins, being deleted altogether.

In the shown embodiment the spline-ended drive-shaft 92 serves also as a steering pivot.

The steering arms 94 and the interconnecting rod 96 thereof are disposed in parallel planes, and the linkage pins 98 of the steering arms 94 are slidingly connected to the corresponding pivot holes of the interconnecting rod 96. This configuration allows elimination of knuckle connections found in conventional steering systems.

The straight-line transmission allows the vertical drive shaft 92 to be connected to the vehicle propulsion drive without the use of a universal joint.

In the shown embodiment, the vehicle's steering arms 94 may be readily detached from their interconnecting rod 96. Consequently the road wheel 64 is free to swivel about its steering pin up to a 90 degrees steering angle between the longitudinal axis of the vehicle's body and the wheel direction, the steering arms 94 being re-attached to connecting rod 96, on returning to the normal driving direction.

Returning to FIG. 2, the gap between the two wheel carrier's arms 46, allows for a conventional horizontal drive-shaft to pass through, thus enabling the utilization of four identical suspensions in an automobile, either for driven or for non-driven wheels.

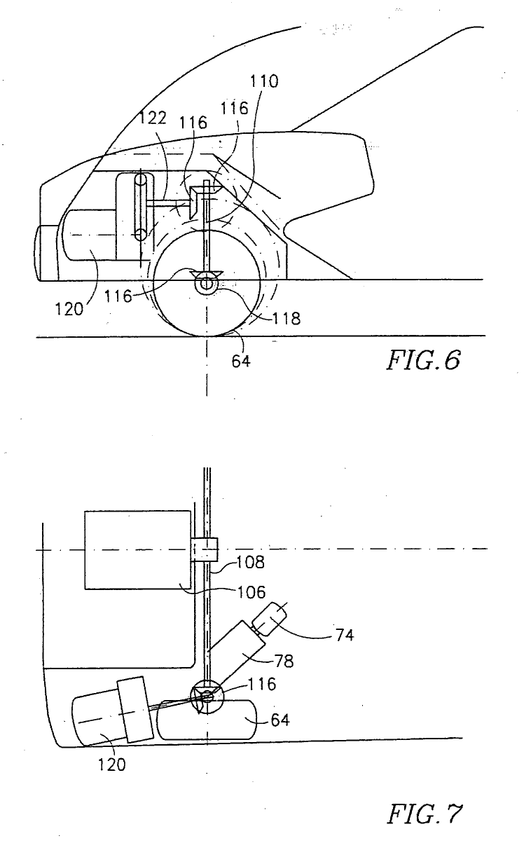

FIGS. 6 & 7 illustrate schematically an embodiment of the suspension-drive for a hybrid vehicle, wherein two or four road wheels 64, are driven by either/both an electric driving unit 120 and an Internal Combustion Engine 106.

The substantially horizontal outlet shaft 108 of engine 106, or the outlet shaft 122 of the electric driving unit 120, drive each, whenever required, the vertical drive-shaft 110, by means of bevel gears 116. Vertical drive-shaft 110 has also a lower bevel gear 116 attached thereto, being in mesh with a bevel gear 118,intended to propel the road wheel 64.

The rotary actuator 74, intended for adjusting the suspension spring 56 of suspension 68 {shown in FIG. 3}, is also illustrated in FIG. 7.

The compactly integrated driving systems as illustrated, provide a remarkably extended internal space of the vehicle to be utilized, as can be seen.

The scope of the described invention is intended to include all embodiments coming within the meaning of the following claims. The foregoing examples illustrate useful forms of the invention, but are not to be considered as limiting its scope, as those skilled in the art will be aware that additional variants and modifications of the invention can readily be formulated without departing from the meanings of the following claims.

1-11. (canceled)

12. An independent automobile suspension, providing a suspended wheel with accurate linear non-guided vertical motions, deriving from a proven geometric formation, comprising:
an upper main arm, its center being pivotally connected to the bottom end of an auxiliary hinged arm, the bottom end of said upper main arm performing straight linear vertical motions, while the upper end of said main arm is guided along a sloped straight slide element;
a bottom main arm provided with end pivot bores identically spaced to those of said upper main arm and pivoted to be parallel to said upper main arm, the bottom ends of said two main arms being pivotally attached to a vehicle's wheel hub so as to restrict said wheel to a constant camber all along its vertical motion; and
a spring operatively connected at one end to a shiftable steady element, for example a “nut-cup” screwed onto a threaded shaft of trapezoidal threads, rotatable by a rotary actuator, said spring connected at its other end to a slide body, slideable freely along the threaded shaft, said spring supporting part of the weight of said automobile, said suspension in combination with a vertical drive-shaft, wherein the compelled linear vertical motions of said drive-shaft, allows for deleting said bottom main arm, and consequently also allows for deleting the arms, connecting the bottom main arm to the upper main arm, said combination forming a suspension drive.

13. The automobile suspension as claimed in claim 12, further comprising a shock absorber, also connected between said steady element and said slide-body, or being located above said vertical drive-shaft, its compelled vertical motions actuating the shock absorber.

14. The automobile suspension as claimed in claim 12, comprising four rotary actuators, wherein the four rotary actuators serve for self-balancing, for responding to centrifugal forces or side-winds, by tilting the vehicle against said forces, as well as for varying the vehicle's height, by determining the relative location of said steady elements to which the springs are connected, through load sensors.

15. The automobile suspension as claimed in claim 12, in combination with a vertical drive-shaft system, for driving a vehicle's road wheel by means of bevel gears, or any other power transmission components, performing the same functions.

16. The automobile suspension as claimed in claim 15, wherein said vertical drive-shaft may serve as a steering pivot.

17. The automobile suspension as claimed in claim 15, wherein the steering arms and the interconnecting rod thereof, are disposed in parallel planes, and the linkage pins of said steering arms are slidingly connected to the corresponding pivot holes of said interconnecting rod, thereby eliminating the need for knuckle joints in the steering system.

18. An automobile provided with suspensions as claimed in claim 15, wherein said vertical drive shafts may be driven by a driving-unit without universal joints, through bevel-gears, through power-grip belts, or any other driving means.

19. The automobile suspension as claimed in claim 15, wherein said vehicle's steering arms may be readily detached from their interconnecting rod, consequently allowing the corresponding wheels to swivel about their steering pins, up to a 90 degrees steering angle between the longitudinal axis of the vehicle's body and the wheels' direction, for “side-traveling”, or to swivel about their steering pins up to an angle allowing the vehicle to turn “on-spot”.
